(19) United States
(12) Patent Application Publication
(10) Pub. No.: US 2026/0091892 A1
(43) Pub. Date: Apr. 2, 2026

(54) AERIAL VEHICLE AND METHOD FOR EMERGENCY LANDING THEREOF

(71) Applicant: Taras Senyk, Brooklyn, NY (US)

(72) Inventor: Taras Senyk, Brooklyn, NY (US)

(21) Appl. No.: 18/389,818

(22) Filed: Dec. 20, 2023

(51) Int. Cl. B64U 20/30; B64U 10/20; B64U 20/20; B64U 20/80; B64U 30/00; B64U 50/14

(52) U.S. Cl. CPC B64U 30/00; B64U 10/20; B64U 20/20; B64U 30/294; B64U 50/14

(57) ABSTRACT

The present invention relates to aerial vehicles and air outlet systems therefor. According to a preferred embodiment of the invention, the aerial vehicle includes a body and at least two thruster assemblies installed in the body. Each thruster assembly includes an air outlet source. An outlet of the air outlet source includes a dome-shaped air deflector. The body includes a plurality of cavities corresponding in its shape to the air outlet source with the dome-shaped air deflector. A control system is installed in the body.

### BACKGROUND OF THE INVENTION

Nowadays, drone production is on a large scale, which gives rise to new solutions and innovations. A large number of unmanned aerial vehicles are configured with propellers. However, the exposed propellers may cause safety problems for operators and others. Various inventions are disclosed in the prior art.

KR20170090797A discloses the aerial vehicle which comprises: jet tails; a motor transmitting compressed air to the jet tails; and a controller controlling movement of the aerial vehicle by controlling the compressed air transmitted to the jet tails.

US20080302920A1 introduces an aircraft and aircraft wing design that has an outer and inner circumference, both of which are employed in the entirety of each to evacuate air, air space, and/or atmosphere from above the circular wing/craft, to the area beneath the circular wing/craft, through the use of a propeller inside the inner circumference of the circular wing, and impellers at the outer circumference of the circular wing.

U.S. Pat. No. 7,201,346B2 discloses a VTOL aircraft which includes a wing, a propulsion system, and an air dam. The propulsion system is located in a central void formed in the wing to cause air flow from an outer perimeter of the wing over the wing and down through the void to generate lift.

JP2004168276A describes a lift generating device with a centrifugal type air blower having a ring-shaped blade, taking air from the center and radially blowing air toward the ring-shaped blade. An air stream is generated in the ring-shaped blade to generate lift.

U.S. Pat. No. 6,666,403B1 discloses a force-generating device employing a flared body and a surrounding shroud to define a duct of axially diminishing flow area defining a nozzle for accelerating and directing the discharge of a fluid at a cambered vane, a pressure dam depends from the bottom surface of the vane to entrap a portion of the fluid flowing chordwise along the bottom surface of the vane. A deflector formed on the enlarged end of the flared body and extending into the duct fluid outlet deflects the fluid stream to increase its velocity and direct it toward the vane.

U.S. Pat. No. 3,697,020A describes a maneuverable lifting body wherein pressurized gas is discharged at supersonic velocity over the surface of at least three downwardly sloping lifting surfaces, the supersonically flowing gas separating and thereafter reattaching to the surface to provide a low pressure region intermediate the points of separation and reattachment.

Although all of the mentioned inventions are characterized by a certain utility and safety, there is often a need to increase their carrying capacity and maneuverability.

The purpose of the present invention is to create an aerial vehicle providing high safety, carrying capacity, and maneuverability characteristics.

Further areas of applicability of the present disclosure will become apparent from the detailed description, the claims and the drawings. The detailed description and specific examples are intended for purposes of illustration only and are not intended to limit the scope of the disclosure.

### SUMMARY OF THE INVENTION

One aspect of the present invention provides an aerial vehicle.

According to a preferred embodiment of the invention, the aerial vehicle includes a body and at least two thruster assemblies installed in the body. Each thruster assembly includes an air outlet source. An outlet of the air outlet source includes a dome-shaped air deflector. The body includes a plurality of cavities corresponding in its shape to the air outlet source with the dome-shaped air deflector. A control system is installed in the body.

Another aspect of the present invention is a method for emergency landing of an aerial vehicle comprising:
transmitting an electric signal from an independent controller to an electric valve;
releasing of a gas from a container with liquefied CO₂ under high pressure by the electric valve;
transmitting the gas through a gas pipeline to the dome-shaped deflector and creating a force counter to the force of gravity;
landing the aerial vehicle.

Various other purposes and advantages of the invention will become clear from its description in the specification that follows and from the novel features particularly pointed out in the appended claims. Therefore, to the accomplishment of the objectives described above, this invention consists of the features hereinafter illustrated in the drawings, fully described in the detailed description of the preferred embodiments and particularly pointed out in the claims. However, such drawings and description disclose only some of the various ways in which the invention may be practiced.

### BRIEF DESCRIPTION OF DRAWINGS

Other assemblies, systems, methods, apparatus, features, and advantages of the present invention will be apparent to one skilled in the art upon examination of the following figures and detailed description. Component parts shown in the drawings are not necessarily to scale, and may be exaggerated to better illustrate the important features of the present invention.

FIG. 1 is a perspective view of an aerial vehicle.

FIG. 2 is a top view of the aerial vehicle.

FIG. 3 is a bottom view of the aerial vehicle.

FIG. 4 is a front view of the aerial vehicle.

FIG. 5 is a perspective view of the disassembled aerial vehicle.

FIG. 6 is a perspective view of a base of a body of the aerial vehicle with a plurality of air outlet sources installed on it.

FIG. 7 is a perspective view of a dome-shaped air deflector of the aerial vehicle with an assembled emergency landing system.

FIG. 8 is a perspective view of a dome-shaped air deflector of the aerial vehicle with the disassembled emergency landing system.

FIG. 9 is a simplified diagram of a control system of the aerial vehicle.

FIG. 10 is a flowchart of a method for emergency landing of the aerial vehicle.

### DETAILED DESCRIPTION OF THE INVENTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

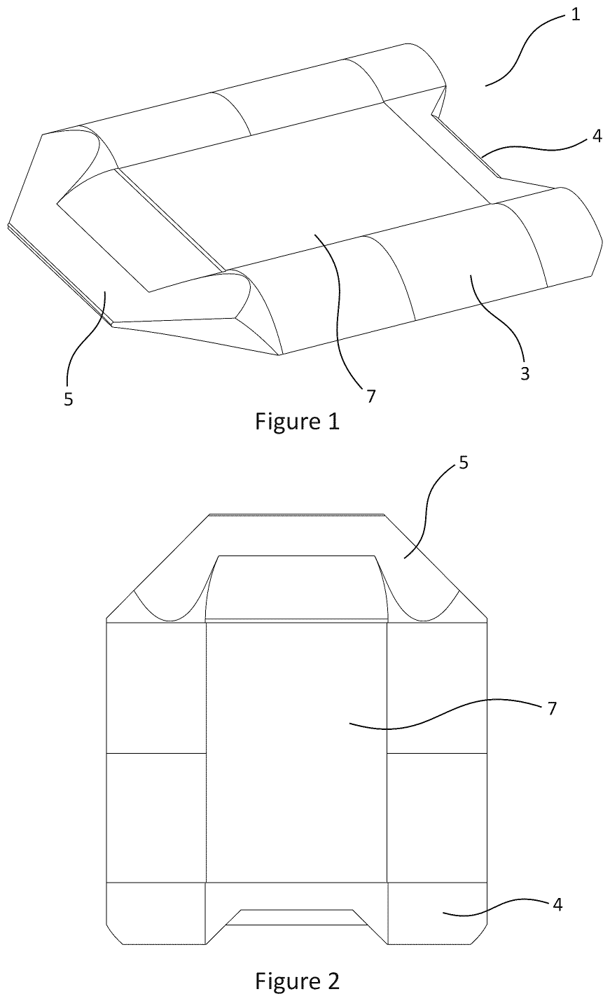

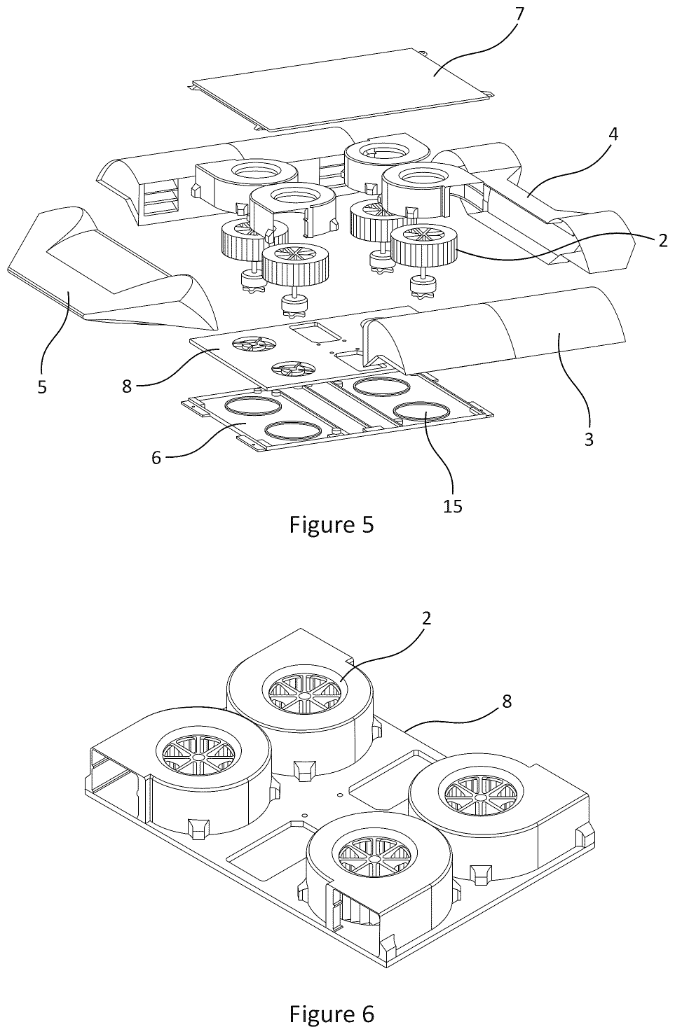

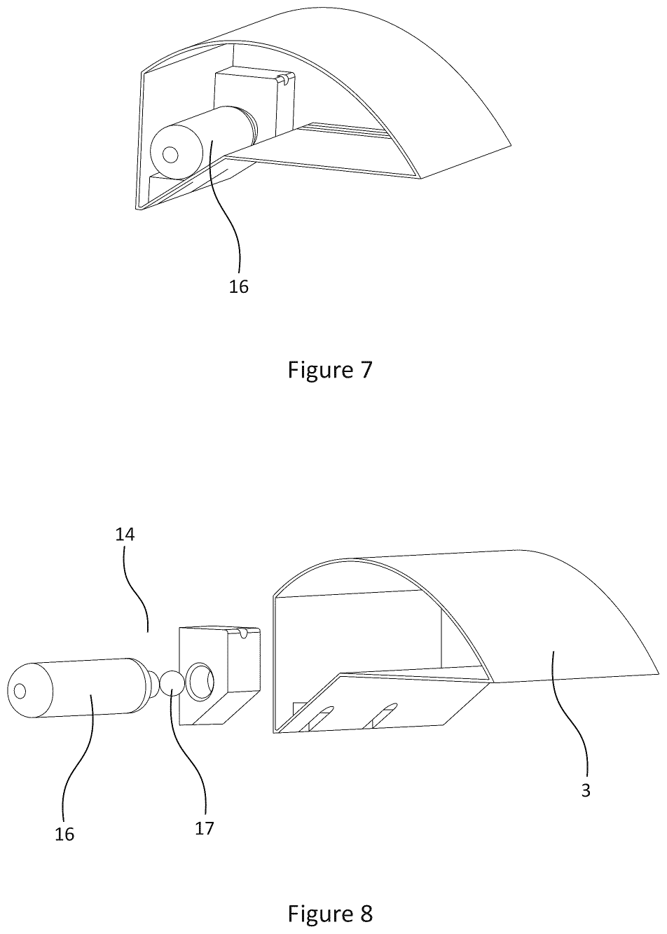

According to a preferred embodiment of the invention (FIGS. 1-8), an aerial vehicle includes a body 1 and at least two thruster assemblies installed in the body. Each thruster assembly includes an air outlet source 2. Each thruster assembly includes a dome-shaped air deflector 3 in mechanical connection with an outlet of the air outlet source 2. The accelerated air produces dynamic pressure on the aerodynamic surfaces on a concave side of the deflector. For example, deflector exit angle may be from 1 to 90 degrees. The body includes a plurality of cavities corresponding in its shape to the air outlet source with the dome-shaped air deflector—this solution ensures the creation of a perfectly streamlined shape.

A control system (FIG. 9) is installed in the body 1.

The body may include a back cover 4, a front cover 5, a bottom cover 6, a top cover 7, and a base 8. The back cover 4, the front cover 5, the bottom cover 6, and the top cover 7 may be configured to provide low air resistance, for example, by achieving high aerodynamic characteristics due to the one-piece dome shape. The base 8 may be configured to install the air outlet source 2 and the control system, as well as other pieces that ensure achievement the purposes of the invention.

The control system (FIG. 9) may include a speed controller 9, a flight controller 10, a radio controller 11, a plurality of energy sources 12, a plurality of sensors 13, and an emergency landing system 14.

The emergency landing system may include an independent energy source, an independent controller, a container 16 with liquefied CO₂ under high pressure, a gas pipeline, and an electric valve 17.

The body 1 may include a plurality of holes 15 configured for air inlet providing by the air outlet source 2.

The preferred embodiment of the invention allows users to use ducted fan or centrifugal fans with a plurality of forward curved blades as air outlet sources. The invention may operate with an ambient air or a gas from a gas source additionally installed in the body.

Although the design of the invention provides high noise reduction performance, the body may additionally be made of noise-absorbing materials.

The aerial vehicle may additionally include a plurality of fastening, holding, and carrying pieces installed on the body to expand the scope of application of the invention.

Another aspect of the present invention is a method for emergency landing of an aerial vehicle (FIGS. 8 and 10) comprising:
transmitting an electric signal from the independent controller to the electric valve;
releasing of the gas from the container 16 with liquefied CO₂ under high pressure by the electric valve 17;
transmitting the gas through the gas pipeline to the dome-shaped deflector 3 and creating a force counter to the force of gravity;
landing the aerial vehicle.

The gas through the short gas pipeline at an angle of 25 to 70 degrees is supplied to the deflectors. The magnitude of the force counter to the force of gravity is chosen so that the falling speed of the aerial vehicle does not exceed 3-5 meters per second. The method is used in case of abnormal operation of the aerial vehicle. In this way, the method ensures safe landing of the aerial vehicle without its damage and without threats to the surrounding environment.

Thus, the invention is characterized by the enclosed body which makes it completely safe to use, all-weather use, low noise, no bottom exhaust, and high maneuverability thanks to servo-controlled deflectors. Tests show that the ratio of weight/power consumption of the invention is from 5 to 12 kg/kW.

Due to its essential features, the aerial vehicle is able to fly at ultra-low altitudes. The principle of operation of the invention scales well in the better direction, and can be used as a base for a heavy flying shuttle—an alternative to helicopters.

While only certain features and embodiments of the disclosure have been illustrated and described, many modifications and changes may occur to those skilled in the art without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosed embodiments. Furthermore, in an effort to provide a concise description of the exemplary embodiments, all features of an actual implementation may not have been described. It should be appreciated that in the development of any such actual implementation, as in any engineering or design project, numerous implementation-specific decisions may be made. Such a development effort might be complex and time-consuming, but would nevertheless be a routine undertaking of design, fabrication, and manufacture for those of ordinary skill having the benefit of this disclosure, without undue experimentation.

1. An aerial vehicle apparatus comprising:
a body;
at least two thruster assemblies installed in the body,
wherein each thruster assembly including an air outlet source,
wherein each thruster assembly including a dome-shaped air deflector in mechanical connection with an outlet of the air outlet source,
wherein the body comprising a plurality of cavities corresponding in its shape to the air outlet source with the dome-shaped air deflector;
a control system installed in the body.

2. The aerial vehicle of claim 1, wherein the body comprising:
a back cover;
a front cover;
a bottom cover;
a top cover;
wherein the back, the front cover, the bottom cover, and the top cover are configured to provide low air resistance;
a base configured to install the air outlet source and the control system.

3. The aerial vehicle of claim 1, wherein control system comprising:
a speed controller;
a flight controller;
a radio controller;
a plurality of energy sources;
a plurality of sensors;
an emergency landing system,
wherein the emergency landing system comprising:
an independent energy source,
an independent controller,
a container with liquefied CO₂ under high pressure,
a gas pipeline, and
an electric valve

4. The aerial vehicle of claim 1, wherein the body comprising a plurality of holes configured for air inlet by the air outlet source.

5. The aerial vehicle of claim 1, wherein the body comprising a plurality of holes configured for air inlet by the air outlet source.

6. The aerial vehicle of claim 1, wherein the air outlet source is a ducted fan.

7. The aerial vehicle of claim 1, wherein the air outlet source is a centrifugal fan with a plurality of forward curved blades.

8. The aerial vehicle of claim 1, wherein the air outlet source is configured for use of a gas from a gas source additionally installed in the body.

9. The aerial vehicle of claim 1, wherein the body is made of noise-absorbing materials.

10. The aerial vehicle of claim 1, further comprising a plurality of fastening, holding, and carrying pieces installed on the body.

11. A method for emergency landing of an aerial vehicle comprising:
transmitting an electric signal from an independent controller to an electric valve;
releasing of a gas from a container with liquefied CO₂ under high pressure by the electric valve;
transmitting the gas through a gas pipeline to a dome-shaped deflector and creating a force counter to the force of gravity;
landing the aerial vehicle.
